(19) United States
(12) Patent Application Publication
(10) Pub. No.: US 2020/0188838 A1
(43) Pub. Date: Jun. 18, 2020

(54) PROCESS AND APPARATUS FOR REGENERATION OF A LADEN SCRUBBING MEDIUM FROM A GAS SCRUBBING

(71) Applicant: L'Air Liquide, Societe Anonyme pour l'Etude et l'Exploitation des Procedes Georges Claude, Paris (FR)

(72) Inventors: Sophia SCHMIDT, Frankfurt (DE); Alfred GUBRINSKI, Erzhausen (DE); Christian FREY, Leimen (DE); Dorit RAPPOLD, Frankfurt (DE); Sharon CORBET, Frankfurt (DE)

(73) Assignee: L'Air Liquide, Societe Anonyme pour l'Etude et l?Exploitation des Procedes Georges Claude, Paris (FR)

(21) Appl. No.: 16/712,298

(22) Filed: Dec. 12, 2019

(30) Foreign Application Priority Data
Dec. 14, 2018 (EP) EP 18020637.7

(51) Int. Cl. B01D 53/14

(52) U.S. Cl. CPC B01D 53/1425; B01D 53/1493; B01D 2252/2021; B01D 53/1475; B01D 53/1468

(57) ABSTRACT

The invention relates to a process for regenerating a laden scrubbing medium from a gas scrubbing for purifying raw synthesis gas in which the laden scrubbing medium is at least partially freed of bound gas constituents in a regeneration stage to obtain a regenerated scrubbing medium. According to the invention it is provided that after withdrawal from the regeneration stage the regenerated scrubbing medium is supplied to an intermediate vessel and the regenerated scrubbing medium is withdrawn from the intermediate vessel and supplied to an absorption apparatus for purifying raw synthesis gas. The invention further relates to an apparatus for performing the process according to the invention comprising a regeneration apparatus in which bound gas constituents are removable from a laden scrubbing medium, wherein according to the invention it is provided that the apparatus comprises an intermediate vessel into which a regenerated scrubbing medium producible in the regeneration apparatus is transferable and in which the regenerated scrubbing medium is storable.

### CROSS REFERENCE TO RELATED APPLICATION

This application claims the benefit of priority under 35 U.S.C. § 119 (a) and (b) to European patent application No. EP18020637.7, filed Dec. 14, 2018, the entire contents of which are incorporated herein by reference.

### FIELD OF THE INVENTION

The invention relates to a process for regenerating a laden scrubbing medium from a gas scrubbing for purification of raw synthesis gas. The invention further relates to an apparatus for regenerating a laden scrubbing medium from a gas scrubbing for purification of raw synthesis gas.

### BACKGROUND OF THE INVENTION

Processes for removal of undesired concomitants from industrial raw synthesis gases by physical or chemical absorption are known from the prior art. Thus such processes may be used to remove, down to trace amounts, unwanted constituents of raw synthesis gases produced by gasification or reforming of carbon-containing inputs, for example carbon dioxide (CO₂) and hydrogen sulfide (H₂S) but also for example carbonyl sulfide (COS) and hydrogen cyanide (HCN), from the wanted synthesis gas constituents such as hydrogen (H₂) and carbon monoxide (CO).

These processes also referred to as gas scrubbings utilize the properties of liquids to absorb gaseous substances and to keep them in solution in physically or chemically bound form. The efficiency with which a gas is absorbed by a liquid is expressed for example by the absorption coefficient also known as the solubility coefficient. The better the absorption or dissolution of the gas in the liquid, the greater the absorption coefficient. In physical gas scrubbings the absorption coefficient generally increases with decreasing temperature and, in accordance with Henry's law, with increasing pressure. In the case of chemical gas scrubbings the amount of the removable gas constituents increases with the amount of the employed chemical absorption medium which binds the removable gas constituents more or less selectively. The liquids employed in gas scrubbings are generally also referred to as scrubbing media.

Subsequent to the gas scrubbing, components scrubbed out of the raw synthesis gas in the gas scrubbing are removed from the laden scrubbing medium to obtain a regenerated or at least partially regenerated scrubbing medium.

In the case of physical gas scrubbings known processes for regenerating the scrubbing medium are decompression (flashing), decompression with stripping gas (stripping) and depressurization with stripping gas where the intrinsic vapour of the scrubbing medium is used as the stripping gas (hot regeneration). In order to be usable for renewed absorption of gas components from the raw synthesis gas a physical scrubbing medium is typically subjected to a hot regeneration in the last regeneration stage. The hot regeneration recovers a virtually pure scrubbing medium which is suitable for the renewed absorption of undesired gas constituents from the raw synthesis gas.

In the case of chemical gas scrubbings the scrubbing medium may be regenerated by boiling at reduced pressure for example.

A known and often employed physical gas scrubbing process is the Rectisol process which is described in principle in Ullmann's Encyclopedia of Industrial Chemistry, 6th Ed. Vol. 15, p. 399 et seq. In the Rectisol process the undesired gas constituents in the raw synthesis gas are absorbed by cryogenic, i.e. cooled to significantly below ambient temperature, methanol as the scrubbing medium. The methanol scrubbing utilizes the fact that the solubility coefficients of H₂S, COS and CO₂ in liquid methanol differ by several orders of magnitude while desired constituents such as H₂ and CO are only insubstantially physically bound by methanol. In practice an intensive mass transfer between the raw synthesis gas and the scrubbing medium takes place during methanol scrubbing in an absorption apparatus (absorption column). The solubility of the unwanted gas constituents increases with decreasing temperature of the methanol and increasing pressure while remaining practically constant for hydrogen and carbon monoxide. Methanol additionally has the advantage of also exhibiting a low viscosity even at temperatures down to −75° C., thus making it usable on a large industrial scale even at very low temperatures.

The regenerated scrubbing medium obtained in the last step of a regeneration stage, for example a hot regeneration, in a gas scrubbing must subsequently be compressed to a high pressure suitable for the absorption.

For example the methanol obtained by hot regeneration in the Rectisol process has a pressure of about 2 bar but must subsequently be compressed to the pressure required for the absorption of 20 to 60 bar by a pump. The regenerated methanol must simultaneously be cooled to the low temperature required for the absorption of −20° C. to −70° C. The cooling is effected via a cooling system comprising a group of 6 to 12 heat exchangers in which the heat of the regenerated methanol is transferred to cold, laden methanol. The cold, laden methanol derives for example from a flash stage of the same gas scrubbing plant.

Since the pump required for compression of the regenerated scrubbing medium is arranged upstream of the group of heat exchangers the heat exchangers must disadvantageously be configured for correspondingly high pressures (used in the absorption).

In order to at least partially avoid the abovementioned disadvantage the regenerated scrubbing medium may also be precompressed to an intermediate pressure of for example 5 to 10 bar by a first pump. The group of heat exchangers arranged downstream must accordingly be configured only for these pressures. Downstream of the heat exchangers the cold scrubbing medium is further compressed to the pressure required for the absorption by a pump.

However, this process mode also has a number of disadvantages. The stripping column used for the hot regeneration typically has a liquid level of regenerated scrubbing medium on a chimney tray which may also be described as the sump of the stripping column. The amount of liquid in this sump cannot be controlled since all other parameters are controlled but at least one degree of freedom must remain. Due to the severely limited volume in the sump of the stripping column this results in reduced flexibility in the operation of the plant in the case of variations in loading. The sump of the stripping column must accordingly be correspondingly large in order thus to be able to intermediately store a certain amount of scrubbing medium during a planned or unplanned stoppage of the plant for example. This results in the stripping column being larger than is actually required and desirable.

Furthermore the pump used for the precompression must have a high NPSHR value (Net Positive Suction Head Required) for cavitation-free operation and must be configured for high temperatures since the scrubbing medium to be conveyed is close to boiling point. Finally, additional equipment is required to operate the second pump, thus increasing the consumption of electrical power due to the operation of the two pumps and further equipment necessary therefor.

Further process modes known from the prior art utilize a dedicated scrubbing medium reservoir vessel which is utilized for storing excess scrubbing medium upon switching to lower gas loadings. Such a reservoir vessel requires at least one pump, instrumentation, safety equipment, tank blanketing with protective gas and a shutoff device to the actual gas scrubbing plant.

DE 10 2013 022 083 discloses a gas scrubbing process in which in the case of an unplanned shutdown of the gas scrubbing plant or during shutdown of only a portion of the gas scrubbing plant scrubbing medium laden with gas constituents is withdrawn from the scrubbing medium circuit and transferred into a degassing vessel in the form of a pressure vessel. A substantially unladen scrubbing medium is withdrawn from the degassing vessel and transferred into a storage vessel. This has the disadvantage that in some cases toxic gas constituents (H₂S, HCN) outgassing from the laden scrubbing medium in the degassing vessel must be withdrawn and supplied to a flare for controlled incineration.

### SUMMARY OF THE INVENTION

The present invention accordingly has for its object to at least partially overcome the abovementioned disadvantages of the prior art.

It is an object of certain embodiments of the present invention to specify a process which at least partially avoids the use of heat exchangers to be operated at high pressures.

It is a further object of certain embodiments of the present invention to specify a process which allows more flexible operation of the apparatus for hot regeneration, in particular in respect of possible adaptations in the case of variations in the load on the apparatus.

It is a further object of certain embodiments of the present invention to specify a process which allows the apparatus for hot regeneration to be smaller, thus saving material and reducing capital expenditure.

It is a further object of certain embodiments of the present invention to specify a process which allows intermediate storage of regenerated scrubbing medium in the case of stoppage of the gas scrubbing plant.

It is a further object of certain embodiments of the present invention to specify a process which allows intermediate storage of regenerated scrubbing medium free from toxic gas constituents in the case of an unplanned shutdown of the gas scrubbing plant, wherein incineration of toxic gas constituents in a flare is at least partially avoidable.

It is a further object of certain embodiments of the present invention to specify a process which does not require a dedicated scrubbing medium reservoir vessel for intermediate storage of excess scrubbing medium upon switching to smaller gas loadings.

It is a further object of certain embodiments of the present invention to specify a process which allows for control of the amount of scrubbing medium in the sump of the regeneration stage, thus making it easier to react to variations in the loading with raw synthesis gas.

It is a further object of certain embodiments of the present invention to specify a process which reduces the consumption of electrical power in respect of the regeneration of the scrubbing medium, thus saving on operating costs.

It is a further object of certain embodiments of the present invention to specify an apparatus or a plant which at least partially achieves at least one of the objects recited above.

The objects of certain embodiments of the invention are at least partially solved by a process for regenerating a laden scrubbing medium from a gas scrubbing for purification of raw synthesis gas in which the laden scrubbing medium is at least partially freed of bound gas constituents in a regeneration stage to obtain a regenerated scrubbing medium. According to the invention it is provided that after withdrawal from the regeneration stage the regenerated scrubbing medium is supplied to an intermediate vessel and the regenerated scrubbing medium is withdrawn from the intermediate vessel and supplied to an absorption apparatus for purifying raw synthesis gas.

According to the invention the scrubbing medium withdrawn from the regeneration stage is initially supplied to an intermediate vessel before it is subsequently withdrawn from the intermediate vessel and supplied to the absorption apparatus for renewed absorption of undesired gas constituents from raw synthesis gas. The introduction of an intermediate vessel into the process allows the operation of the regeneration stage, for example the operation of a stripping column, to be more flexible. Variations in the loading of the gas scrubbing apparatus with raw synthesis gas may be compensated more easily. The introduction of the intermediate vessel into the process allows control of the fill height of the sump of the regeneration stage for the first time. The sump thus no longer serves as a buffer volume for unplanned or planned stoppages of the gas scrubbing plant. Accordingly the sum may be smaller than previously necessary, thus reducing capital expenditure incurred for construction of a gas scrubbing plant. Transferred into the intermediate vessel is a regenerated scrubbing medium which in the case of planned or unplanned stoppages of the plant may be held even for prolonged periods directly in the intermediate vessel since it contains no toxic or environmentally harmful gas constituents. Since the regenerated scrubbing medium exits the regeneration stage at atmospheric pressure or a pressure only slightly above ambient pressure (for example 2 bar) the intermediate vessel need not be a pressure vessel. A process comprising a pressure vessel from which constituents outgassing after decompression must be sent to the flare due to their toxicity and potential environmental harmfulness is thus obviated. The process according to the invention requires only one pump, thus reducing capital costs for a second pump and operating costs in respect of electricity consumption. The process according to the invention further allows the regenerated scrubbing medium to be pre-cooled in larger amounts by virtue of the intermediate vessel. The pumps arranged downstream for compression may therefore be smaller.

The “gas scrubbing” is a gas scrubbing based on physical absorption in a physical scrubbing medium, a gas scrubbing based on chemical absorption in a chemical scrubbing medium or a combination thereof.

In the context of the subject matter of the invention a “laden scrubbing medium” is to be understood as meaning a scrubbing medium in which gas constituents are physically or chemically absorbed. The loading of the scrubbing medium is to be understood as a reversible operation, i.e. by regeneration of the scrubbing medium gas constituents may be at least partially desorbed from the scrubbing medium again. The “regeneration” can, but need not, proceed completely so that a partially or completely regenerated scrubbing medium is obtained by regeneration.

In the context of the subject matter of the invention a “raw synthesis gas” is to be understood as meaning a product gas mixture from a chemical reaction of a carbon-containing feedstock which contains at least the products carbon monoxide (CO) and hydrogen (H₂) as desired constituents as well as undesired constituents which are removable by a gas scrubbing.

In the context of the subject matter of the invention a “regeneration stage” is to be understood as meaning a process step which brings about an at least partial regeneration of the laden scrubbing medium using a regeneration apparatus. The laden scrubbing medium is at least partially freed of bound gas constituents. The regeneration stage is preferably a stage containing a hot regeneration step. In a hot regeneration step the laden scrubbing medium is largely or completely regenerated so that it has a purity of at least 99% by weight, preferably a purity of at least 99.5% by weight, more preferably a purity of at least 99.9% by weight.

After withdrawal from the regeneration stage the regenerated scrubbing medium is supplied to an intermediate vessel. After withdrawal from the regeneration stage the regenerated scrubbing medium is supplied to the intermediate vessel directly or indirectly. In the latter case the regenerated scrubbing medium is subjected to further process steps before it is supplied to the intermediate vessel.

In the context of the subject matter of the invention an “intermediate vessel” is to be understood as meaning a vessel which is suitable in principle for the holding and/or storage of regenerated scrubbing medium. In the context of the configuration of a gas scrubbing plant the intermediate vessel is arranged between two further components of the gas scrubbing plant. The intermediate vessel is in particular connected to two further components of the gas scrubbing plant by fluid connections and the intermediate vessel is thus arranged between these components by means of the fluid connections.

The regenerated scrubbing medium is withdrawn from the intermediate vessel and supplied to an absorption apparatus for purifying raw synthesis gas. After withdrawal from the intermediate vessel the regenerated scrubbing medium is supplied to the absorption apparatus directly or indirectly. In the latter case the regenerated scrubbing medium is subjected to further process steps before it is supplied to the absorption apparatus.

A preferred embodiment of the process according to the invention is characterized in that the gas scrubbing is a physical gas scrubbing. The abovementioned advantages of the process according to the invention are brought to bear in particular in physical gas scrubbings since in this type of gas scrubbings the scrubbing medium is under high pressure in the absorption apparatus to exploit the pressure dependency of the absorption coefficient.

In physical gas scrubbings the solubility of the gas constituents to be removed in the scrubbing medium is brought about by physical interactions. Examples of physical scrubbing media employed in industrial gas scrubbing processes are methanol, N-methyl-2-pyrrolidione (NMP), polyethylene glycol dimethyl ether (DMPEG), n-oligoethylene glycol methyl isopropyl ether (MPE) and N-methylcaprolactam (NMC).

A preferred embodiment of the process according to the invention is characterized in that the scrubbing medium comprises methanol as the main constituent, preferably consists of methanol. In the present context the term “scrubbing medium” relates to the scrubbing medium not laden with gas constituents. In the present context “main constituent” is to be understood as meaning that the proportion of methanol in the scrubbing medium is at least 50% by weight or at least 75% by weight or at least 90% by weight or at least 95% by weight or at least 99% by weight. It is preferable when the scrubbing medium consists of methanol, i.e. pure methanol having a purity of at least 99.5% by weight or higher. The abovementioned advantages of the process according to the invention are brought to bear in particular in the case of methanol as the physical scrubbing medium since methanol is cooled to very low temperatures, generally −20° C. to −70° C., for use in the absorption apparatus to optimally exploit the temperature dependence of the absorption coefficient and the higher selectivity of methanol for the gas components to be removed at low temperatures.

In chemical gas scrubbings, one embodiment of the process according to the invention, the absorption of the gas constituents to be removed in the scrubbing medium is brought about by chemical interactions, in particular chemical bonds. One example of such a chemical interaction is an acid-base interaction. One example of an acid-base interaction is the binding of an acid gas, for example of hydrogen sulfide (H₂S), by an amine, for example a primary, secondary and/or tertiary amine or a corresponding amino alcohol. Examples of suitable amines or amino alcohols are monoethanolamine (MEA), diethanolamine (DEA), diglycolamine (DGA), diisopropylamine (DIPA), methyldiethanolamine (MDEA), activated methyldiethanolamine (aMDEA) and generally sterically hindered amines or amino alcohols.

In one embodiment of the process according to the invention the gas scrubbing is a combination of a physical and a chemical gas scrubbing. In this case a combination of at least one physical scrubbing medium and at least one chemical scrubbing medium is used. Two examples of such combinations are firstly a mixture of DIPA, sulfolane (tetrahydrothiophene-1,1-dioxide) and water and secondly a mixture of MEA or DEA and methanol.

A preferred embodiment of the process according to the invention is characterized in that laden scrubbing medium is withdrawn from the absorption apparatus and subsequently supplied to a decompression stage to obtain laden scrubbing medium having a reduced concentration of bound gas constituents which is withdrawn from the decompression stage and supplied to the regeneration stage.

It is preferable when the cold, laden scrubbing medium is not immediately withdrawn from the absorption apparatus but rather initially passes through at least one decompression stage (flash stage) before it is supplied for example to a hot regeneration as a regeneration stage. The pressure reduction in the decompression stage liberates cold gases, thus reducing the concentration of bound gas constituents in the laden scrubbing medium. The liberated cold gases may be used for cooling elsewhere in the gas scrubbing process by indirect heat exchange with other media. Examples include the cooling of raw synthesis gas or the additional cooling of regenerated scrubbing medium, in particular methanol. The colder the scrubbing medium in the absorption the less scrubbing medium is required. This advantageously allows the intermediate vessel to be made correspondingly smaller.

The depressurization stage may comprise one or more serially connected so-called “flash vessels” wherein in the case of a plurality of flash vessels the pressure falls from vessel to vessel.

Laden scrubbing medium withdrawn from the decompression stage may further be supplied to a reabsorber before it is supplied to the regeneration stage. The use of a reabsorber is provided for in the so-called selective Rectisol process in particular but is also conceivable in other gas scrubbing processes. According to the selective Rectisol process CO₂ is stripped out of the laden scrubbing medium (methanol) by an inert gas such as N₂ in the reabsorber. Any unintentionally co-stripped H₂S is subsequently reabsorbed by cold methanol supplied to the reabsorber. As a result it subsequently passes into the regeneration stage in which the H₂S is exgelled from the scrubbing medium by stripping with methanol vapour and subsequently supplied to a Claus plant for recovery of elemental sulfur.

It has been found that the use of an additional decompression stage surprisingly shows additional advantages. The amount of valuable gases (H₂, CO) arriving in the intermediate vessel with regenerated scrubbing medium is significantly reduced. This increases the proportion of recovered valuable gases that were unintentionally but unavoidably absorbed by the scrubbing medium. The amount of undesired gas constituents such as H₂S introduced into the intermediate vessel is simultaneously reduced. This results in the advantage that a greater amount of H₂S passes into the regeneration stage, for example a hot regenerator, so that more H₂S is available for the sulfur recovery in the Claus process. Material-specific advantages also result since less corrosive H₂S outgasses in the intermediate vessel. The demands on the material used for the intermediate vessel in respect of corrosion propensity are correspondingly lower. It is altogether advantageous when as few gases as possible are introduced into the intermediate vessel with the regenerated methanol since it is often technically problematic for a gas cushion built up over time to be removed again, in particular in the case of toxic gases such as CO and H₂S.

It has further been found that when using a decompression stage the scrubbing medium supplied to the regeneration stage has a lower temperature compared to the process mode without a decompression stage. Accordingly, the scrubbing medium exiting the regeneration stage likewise has a lower temperature after heat exchange so that a downstream pump requires a lower NPSH value (NPSHR is reduced) and the intermediate vessel has a lower operating temperature as a result of which the design temperature of the intermediate vessel is also reduced. This altogether reduces the capital costs for the required equipment.

A preferred embodiment of the process according to the invention is characterized in that the regenerated scrubbing medium is cooled after withdrawal from the regeneration stage and/or after withdrawal from the intermediate vessel. When the regenerated scrubbing medium is cooled after withdrawal from the regeneration stage a greater amount of already pre-cooled scrubbing medium collects in the intermediate vessel. Downstream pumps used for compression may therefore be smaller. It is preferable when the regenerated scrubbing medium withdrawn from the intermediate vessel and subsequently compressed to the absorption pressure is subsequently cooled to the temperature optimal for the absorption.

It is preferable when this cooling is carried out by indirect heat transfer to a cold, laden scrubbing medium. For optimal heat integration the heat of the regenerated scrubbing medium is transferred to cold and laden scrubbing medium withdrawn from the absorption apparatus or the decompression stage.

A preferred embodiment of the process according to the invention is characterized in that after withdrawal from the intermediate vessel the regenerated scrubbing medium is compressed to a pressure suitable for operating the absorption apparatus. The regenerated scrubbing medium is advantageously compressed to the pressure required for the absorption in the absorption apparatus only after withdrawal from the intermediate vessel. In this type of the process mode the intermediate vessel may be configured for standard pressure, i.e. the intermediate vessel need not be a pressure vessel.

A preferred embodiment of the process according to the invention is characterized in that an amount of regenerated scrubbing medium present in the intermediate vessel is established as a controlled variable via a fill level of regenerated scrubbing medium in the regeneration stage. It is preferable when the fill level of regenerated scrubbing medium in the regeneration stage is the fill level in the sump of the apparatus used for the regeneration stage. In one example the “sump” is a region on a gas-permeable tray in an apparatus used for the regeneration stage. In one example the gas-permeable tray is a chimney tray, for example in a stripping column, on which the liquid, here the regenerated scrubbing medium, collects. Since the fill level of regenerated scrubbing medium in the apparatus used for the regeneration stage represents the controlled variable the height of the fill level can determine the amount of regenerated scrubbing medium withdrawn from the regeneration stage and transferred into the intermediate vessel. It is preferable when the fill level is controlled such that it has a largely constant target value. This makes it possible to react in simple fashion to variations in the loading of the gas scrubbing apparatus with raw synthesis gas. If for example the amount of raw synthesis gas is increased and the amount of circulating scrubbing medium must be increased accordingly, a relatively greater amount of regenerated scrubbing medium must be removed from the regeneration stage to ensure a constant fill level. Accordingly a relatively larger amount of regenerated scrubbing medium is transferred into the intermediate vessel. The abovementioned principal thus ensures increased flexibility during operation of the apparatus used for the regeneration stage. The specification of the fill level as a controlled variable in conjunction with the intermediate vessel obviates the need for the apparatus used for the regeneration stage, for example the sump of a stripping column, to be unnecessarily large. In other words it is no longer necessary to provide a portion of the apparatus used for the regeneration stage as a buffer zone for “storage” of regenerated scrubbing medium in this apparatus.

A preferred embodiment of the process according to the invention is characterized in that the supplying to the intermediate vessel is carried out continuously or periodically or in batch operation, i.e. batchwise. When the gas scrubbing plant is in operation the supplying of the regenerated scrubbing medium to the intermediate vessel is carried out continuously or periodically. Periodic supplying is to be understood as meaning a special case of continuous supplying where the feed mass flow is alternatingly zero or non-zero. However in certain cases it is also conceivable to fill the intermediate vessel with regenerated scrubbing medium on a batchwise basis, for example during testing of a gas scrubbing plant after technical problems have occurred or during startup of the plant.

A preferred embodiment of the process according to the invention is characterized in that the laden scrubbing medium is regenerated by stripping, preferably by stripping with scrubbing medium vapour, in the regeneration stage. In order to free the laden scrubbing medium from absorbed gas constituents completely or at least virtually completely the regeneration in the regeneration stage is effected by a depressurization in conjunction with the supply of a stripping gas into the scrubbing medium to drive out absorbed gas constituents. When the stripping gas is scrubbing medium vapour, for example produced by a reboiler, this is also known as hot regeneration. Especially hot regeneration affords a largely pure, i.e. completely regenerated, scrubbing medium.

A preferred embodiment of the process according to the invention is characterized in that the raw synthesis gas comprises at least carbon monoxide (CO), hydrogen (H₂), carbon dioxide (CO₂) and hydrogen sulfide (H₂S) and optionally at least one element from the group consisting of carbonyl sulfide (COS), mercaptans (RSH), hydrogen cyanide (HCN) and ammonia (NH₃). CO and H₂ are the desired components of the raw synthesis gas. A gas mixture comprising exclusively CO and H₂ may therefore also be referred to as “pure” synthesis gas. In one processing step of the raw synthesis gas carbon monoxide may be reacted with water in the socalled water-gas shift reaction to afford CO₂ and H₂ in order to increase the H₂ proportion in the synthesis gas. All other of the abovementioned components are undesired components and are preferably completely removed by absorption in the gas scrubbing process. Very small residual amounts of these components (ppm range) may be tolerable depending on the specification stipulated.

The objects of the invention are further at least partially achieved by an apparatus for regenerating a laden scrubbing medium from a gas scrubbing for purification of raw synthesis gas comprising the following constituents in fluid connection with one another: a regeneration apparatus in which bound gas constituents are removable from a laden scrubbing medium, wherein according to the invention it is provided that the apparatus comprises an intermediate vessel into which a regenerated scrubbing medium producible in the regeneration apparatus is transferable and in which the regenerated scrubbing medium is storable.

The apparatus according to the invention is suitable for regenerating a laden scrubbing medium, wherein the scrubbing medium is used in a gas scrubbing for purification of raw synthesis gas. For this reason the apparatus according to the invention comprises a regeneration apparatus in which bound gas constituents are removable from a laden scrubbing medium. It is preferable when the bound gas constituents are reversibly bound to the scrubbing medium by physical or chemical absorption or a combination thereof.

The regeneration apparatus is selected from apparatuses known to those skilled in the art such as for example a stripping column that may be operated with a stripping gas, preferably an inert gas such as for example nitrogen, or with scrubbing medium vapour as the stripping gas.

According to the invention the apparatus comprises an intermediate vessel which is connected to the regeneration apparatus via a fluid connection. A fluid connection is a connection which is suitable for transporting any desired fluids, for example for transporting gases or liquids. The intermediate vessel is directly or indirectly connected to the regeneration apparatus. In the latter case the intermediate vessel and the regeneration apparatus may have arranged between them further components which are in turn connected to one another/to the intermediate vessel or the regeneration apparatus via fluid connections. Examples of further components include a pump and a heat exchanger.

The regenerated scrubbing medium producible in the regeneration apparatuses is transferable into the intermediate vessel and may be stored therein. The intermediate vessel is preferably in the form of a vessel which may be operated at atmospheric pressure or slightly above atmospheric pressure (for example 2 bar). The intermediate vessel is preferably not in the form of a pressure vessel for intermediate or high operating pressures. In one example “intermediate pressures” are pressures between 5 and 10 bar. In one example “high pressures” are pressures between 10 and 100 bar. The regenerated scrubbing medium is storable in the intermediate vessel, i.e. it may be stored in the intermediate vessel for the purposes of storage, for example in the case of an unplanned or planned stoppage. Further safety measures are not necessary since the regenerated scrubbing medium contains no toxic or environmentally harmful gas constituents on account of the upstream regeneration stage.

The intermediate vessel is preferably connected to an absorption apparatus via a fluid connection. As a result regenerated scrubbing medium present in the intermediate vessel is transferable into the absorption apparatus and may be used in the absorption apparatus to absorb further undesired gas constituents from a raw synthesis gas.

The intermediate vessel is directly or indirectly connected to the absorption apparatus. In the latter case the intermediate vessel and the absorption apparatus may have arranged between them further components which are in turn connected to one another/to the intermediate vessel or the absorption apparatus via fluid connections. Examples of further components include a pump and a heat exchanger.

The intermediate vessel is arranged between the absorption apparatus and the regeneration apparatus and connected to the absorption apparatus and the regeneration apparatus in each case directly or indirectly via fluid connections.

A preferred embodiment of the apparatus according to the invention is characterized in that a pump for compressing the regenerated scrubbing medium is arranged downstream of the intermediate vessel. It is preferable when the regenerated scrubbing medium present in the intermediate vessel is compressed by a pump to a pressure that is suitable for the subsequent absorption in an absorption apparatus on account of the pressure dependence of the absorption coefficient, especially in the case of physical scrubbing medium, after discharging from the intermediate vessel. In the context of the subject matter of the invention “downstream” is to be understood as meaning that a downstream element is arranged behind a further element in the flow direction of the medium at issue. The abovementioned principle applies vice versa for “upstream” elements.

A preferred embodiment of the apparatus according to the invention is characterized in that a heat exchanger for cooling the regenerated scrubbing medium is arranged upstream and/or downstream of the intermediate vessel. If the regenerated scrubbing medium is cooled by a heat exchanger after withdrawal from the regeneration apparatus the intermediate vessel can store a greater amount of already pre-cooled scrubbing medium, thus allowing downstream pumps used for the compression to be made smaller. It is preferable when regenerated scrubbing medium withdrawn from the intermediate vessel and subsequently compressed to absorption pressure is cooled to a temperature optimal for the absorption by a downstream heat exchanger.

A preferred embodiment of the apparatus according to the invention is characterized in that the regeneration apparatus comprises a stripping column comprising a reboiler, overhead condenser and at least one gas-permeable tray. It is preferable when the regeneration apparatus is an apparatus suitable for the hot regeneration which accordingly comprises a reboiler for evaporating the scrubbing medium, an overhead condenser for condensing the regenerated scrubbing medium and a gas-permeable tray. The condensed regenerated scrubbing medium collects on the gas-permeable tray. The gas-permeable tray may be in the form of a chimney tray for example. The gas-permeable tray is also referred to as the sump or sump region of the regeneration apparatus. The regenerated scrubbing medium is withdrawable from the sump of the regeneration apparatus and transferable into the intermediate vessel.

A preferred embodiment of the apparatus according to the invention is characterized in that the intermediate vessel has an actuated device for flow rate control arranged upstream of it. The intermediate vessel according to the invention makes it possible for the first time to control the amount of the scrubbing medium withdrawable from the regeneration apparatus. An actuated device arranged upstream of the intermediate vessel determines the amount of regenerated scrubbing medium supplied to the intermediate vessel according to the amount of scrubbing medium circulating in the scrubbing medium circuit via a control apparatus. The actuated device is in one example a valve.

The regeneration apparatus preferably comprises a control apparatus for controlling the flow rate of the actuated device via a fill level of regenerated scrubbing medium in the regeneration apparatus as a controlled variable, thus establishing a fill level of regenerated scrubbing medium in the intermediate vessel. The control apparatus ensures a largely constant fill level (constant target value) of regenerated scrubbing medium in the regeneration stage. Accordingly the flow rate through the actuated device increases in case of an increase in the circulating amount of scrubbing medium, for example due to an increase in the supplied amount of raw synthesis gas per unit time. A higher fill level of regenerated scrubbing medium may accordingly be established in the intermediate vessel according to the amount of scrubbing medium withdrawn from the intermediate vessel. According to the invention it is therefore advantageously possible to eschew a buffer volume inside the regeneration apparatus since variations in the loading with raw synthesis gas may be simply compensated in conjunction with the intermediate vessel by controlling the fill level of regenerated scrubbing medium in the regeneration apparatus.

### BRIEF DESCRIPTION OF THE DRAWINGS

The invention is more particularly elucidated herein below by way of an example without limiting the subject matter of the invention. Further features, advantages and possible applications of the invention will be apparent from the following description of the working example in conjunction with the drawings.

FIG. 1 shows a schematic flow diagram of a process/an apparatus 100 for regenerating a laden scrubbing medium according to the prior art,

FIG. 2 shows a schematic flow diagram of a process/an apparatus 200 for regenerating a laden scrubbing medium according to the prior art,

FIG. 3 shows a schematic flow diagram of a process/an apparatus 300 for regenerating a laden scrubbing medium according to one embodiment of the invention, and

FIG. 4 shows a schematic flow diagram of a process/an apparatus 400 for regenerating a laden scrubbing medium according to a further embodiment of the invention.

### DETAILED DESCRIPTION OF THE INVENTION

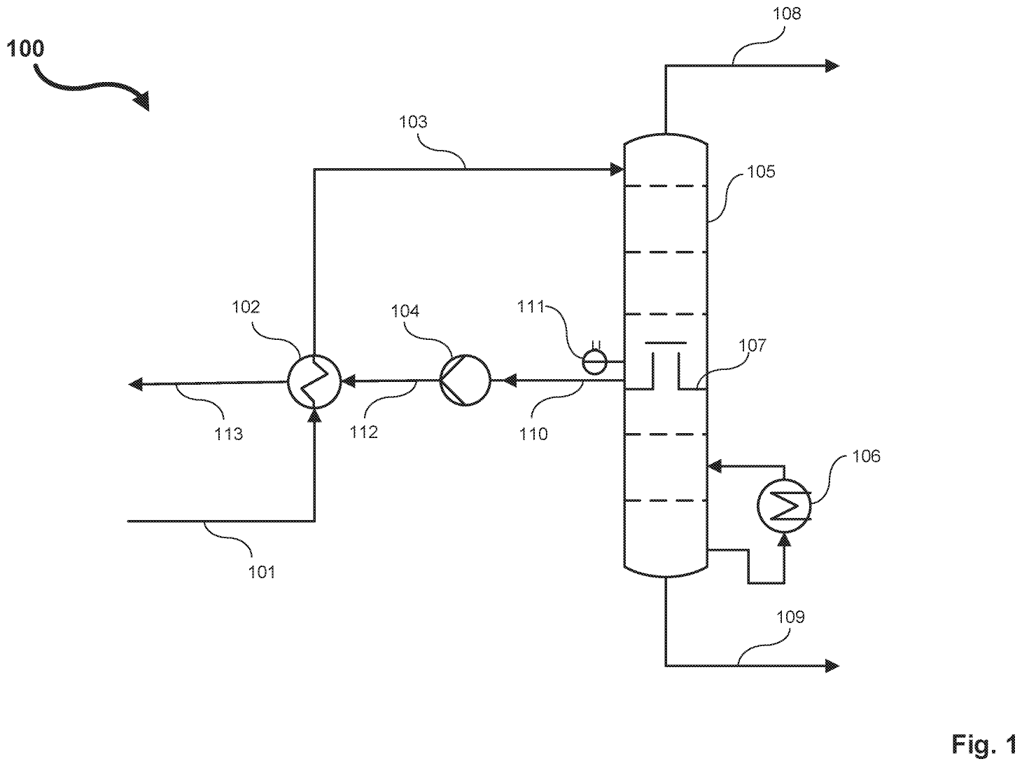

FIG. 1 shows a schematic flow diagram of a process or an apparatus 100 for regenerating a laden scrubbing medium such as is known from the prior art. In the comparative example of FIG. 1 methanol is used as the scrubbing medium and regenerated using an apparatus for hot regeneration. Cold methanol laden with undesired synthesis gas constituents and withdrawn from a flash stage (not shown) arranged downstream of an absorption apparatus (not shown) was supplied via conduit 101. The cold methanol in conduit 101 is laden at least with hydrogen sulfide (H₂S) and hydrogen cyanide (HCN) as components to be removed. The cold laden methanol is preheated with regenerated methanol in countercurrent in indirect heat exchanger 102 and supplied via conduit 103 to the regeneration apparatus 105.

Regeneration apparatus 105 comprises a reboiler 106 in a lower region, a chimney tray 107 in a middle region and an overhead condenser (not shown) in an upper region. The methanol vapours produced by the reboiler 106 expel the undesired components H₂S and HCN from the laden methanol and the components exit the regeneration apparatus via conduit 108 together with methanol not condensed by the overhead condenser. Once methanol has been condensed out of the gas mixture, the remaining gas mixture of H₂S and HCN is subsequently supplied to a Claus plant for sulfur recovery (not shown). Methanol accumulated in the lower region of the regeneration apparatus has been enriched with water and is withdrawn via conduit 109 and supplied to a distillation apparatus (not shown) for methanol/water separation.

Regenerated methanol condensed by the overhead condenser collects on the chimney tray 107. Chimney tray 107 is fitted with a fill level measuring apparatus 111 (LI=level indication). Fill level measuring apparatus 111 makes it possible to measure and check the fill level on chimney tray 107 but not to control the fill level. Chimney tray 107 is correspondingly large to be able to absorb also relatively large amounts of regenerated methanol in case of variations in the amount of the raw synthesis gas feed and thus variations in the amount of the circulating methanol. Regenerated methanol withdrawn from the chimney tray 107 is supplied via conduit 110 to a pump 104 for compression to the pressure prevailing in the absorption apparatus (for example 60 bar). The compressed regenerated methanol finally passes via conduit 112 into the indirect heat exchanger 102 and is therein cooled against cold methanol from conduit 101 to the low temperature required for the absorption (for example −50° C.). The cryogenic methanol is subsequently supplied to the absorption apparatus (not shown) via conduit 113 for renewed absorption of gas constituents from raw synthesis gas. Indirect heat exchanger 102 is shown as a single heat exchanger in FIG. 1. In practice said heat exchanger is typically a group of two or more heat exchangers, wherein one or more of these heat exchangers may have a dedicated coolant supply. The abovementioned heat exchangers must be configured for the high pressures (for example 60 bar) prevailing in the absorption apparatus.

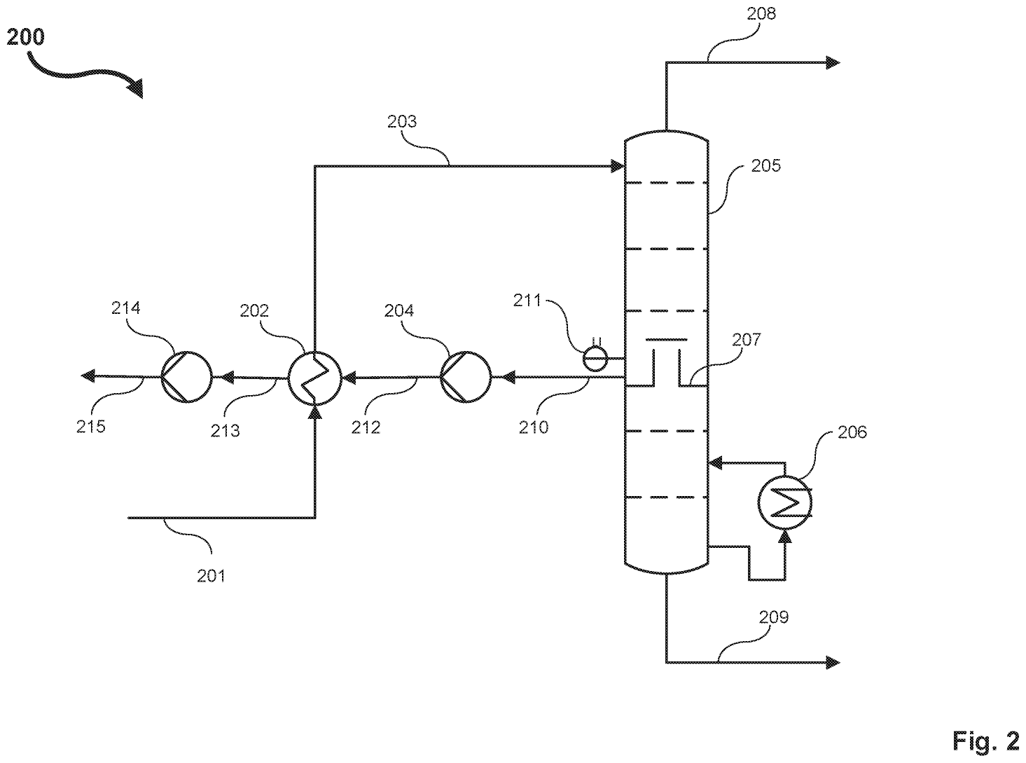

FIG. 2 shows a schematic flow diagram of a process or an apparatus 200 for regenerating a laden scrubbing medium such as is known from the prior art. In the comparative example of FIG. 2 methanol is used as the scrubbing medium and regenerated using an apparatus for hot regeneration.

Reference numerals for elements in FIG. 1 having the same tens and units in the numeral as in FIG. 2 correspond to identical elements. For example the conduit 101 in FIG. 1 corresponds to the conduit 201 in FIG. 2. The hundreds in the reference numeral indicate the number of the respective figure.

The process/the apparatus 200 according to FIG. 2 differs from the process/the apparatus 100 according to FIG. 1 in that a second pump 214 and an additional conduit 215 are used. In the comparative example of FIG. 2 regenerated methanol withdrawn from the regeneration apparatus 205 via conduit 210 is supplied to a pump 204 in which the regenerated methanol is precompressed to an intermediate pressure (for example 10 bar). After cooling in heat exchanger 202 the precompressed methanol is compressed by pump 214 to the high pressure required for the absorption (for example 60 bar) and supplied to an absorption apparatus (not shown) via conduit 215.

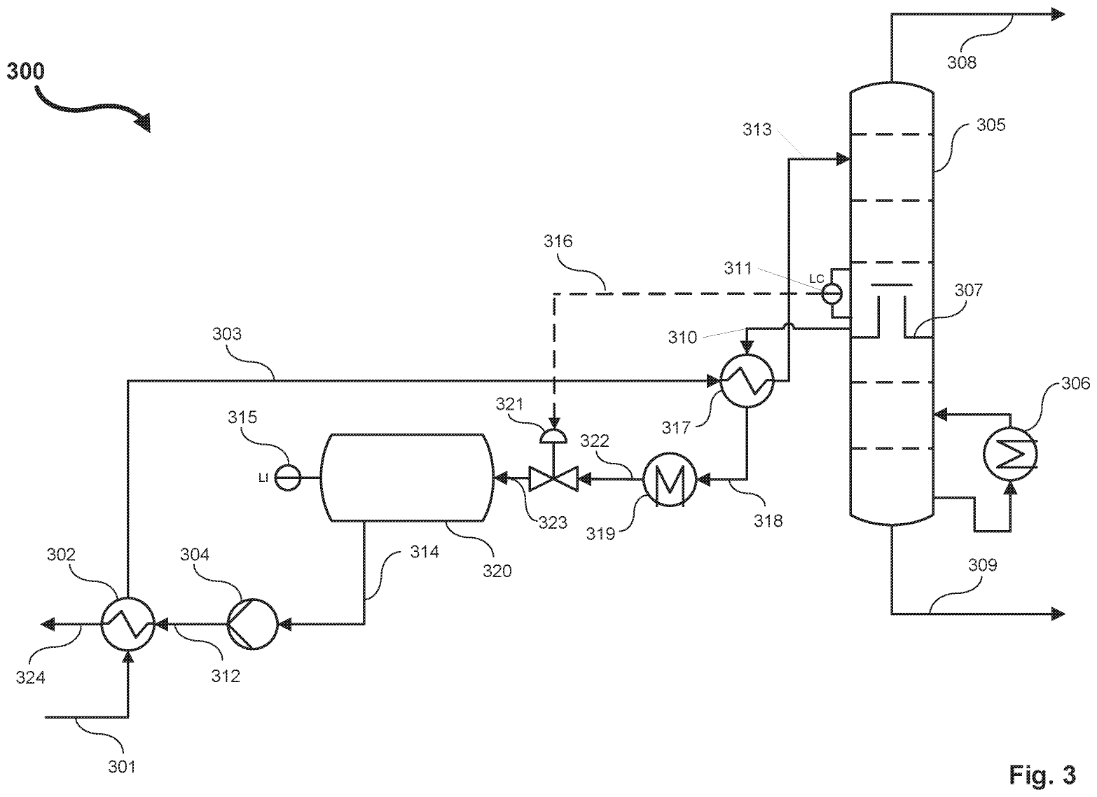

FIG. 3 shows a schematic flow diagram of a process or an apparatus 300 for regenerating a laden scrubbing medium according to one working example of the invention. In the inventive example of FIG. 3 methanol is used as the scrubbing medium and regenerated using an apparatus for hot regeneration.

Via conduit 301 methanol laden with at least hydrogen sulfide (H₂S) and hydrogen cyanide (HCN) is supplied from an absorption apparatus (not shown) and initially preheated against regenerated methanol from regeneration apparatus 305 in indirect heat exchanger 302. The laden methanol subsequently passes into heat exchanger 317 where it is preheated against regenerated methanol from regeneration apparatus 305 in a further heat exchanger stage before it is supplied to the regeneration apparatus 305 via conduit 313. Regeneration apparatus 305 is in the form of a stripping column for hot regeneration and comprises a reboiler 306, a chimney tray 307 and an overhead condenser (not shown). Laden methanol is largely freed of H₂S and HCN in the regeneration apparatus 305 using methanol vapours produced by the reboiler 306. Abovementioned gas constituents not desired in the synthesis gas exit the regeneration apparatus 305 via conduit 308 together with methanol vapours not completely condensed by the overhead condenser. Once the methanol vapours have been condensed out of the H₂S- and HCN-containing acid gas mixture in a separator the acid gas mixture is supplied to a Claus plant for recovery of sulfur (not shown).

Accumulating in the lower region of the regeneration apparatus 305 is methanol enriched with water which is withdrawn via conduit 309 and supplied to a distillation apparatus for methanol-water separation.

Regenerated methanol freed of all acid gases accumulates on chimney tray 307. In the context of the invention chimney tray 307 is also referred to as the sump of the regeneration apparatus. The fill level on chimney tray 307 is controlled via the fill level control apparatus 311. The fill level control apparatus 311 controls the amount of regenerated methanol withdrawn from the regeneration apparatus via conduit 310. If the synthesis gas feed and thus the circulating amount of methanol is increased for example a greater amount of regenerated methanol per unit time is withdrawn via conduit 310 to keep constant the fill level on the chimney tray 307. Fill level control apparatus 311 controls the amount to be removed via conduit using an actuated device, in this case control valve 321, which is in communication with fill level control apparatus 311 via a control circuit 316. Regenerated methanol withdrawn via conduit 310 is pre-cooled against laden methanol from conduit 303 in the indirect heat exchanger 317, passes via conduit 318 into a further heat exchanger 319 and finally via the conduits 322 and 323 and control valve 321 into intermediate vessel 320. Intermediate vessel 320 is configured for standard pressure or slight positive pressure as the operating pressure (for example 2 bar). Intermediate vessel 320 is optionally thermally insulated, i.e. provided on its outside with an insulating layer, in order that the pre-cooled regenerated methanol in the intermediate vessel 320 ideally does not undergo any warming. To check the fill level, intermediate vessel 320 is equipped with a fill level measuring apparatus 315. Intermediate vessel 320 is suitable for long-term storage of regenerated methanol and is therefore made of a material suitable therefor.

Due to the presence of the intermediate container 320 in conjunction with the components 311, 316 and 321 of the control apparatus, regeneration apparatus 305, in particular the region around the chimney tray 307 or sump, is smaller than regeneration apparatuses 105, 205 of the comparative examples.

Pre-cooled, regenerated methanol is withdrawn from intermediate vessel 320 via conduit 314 and compressed to the pressure prevailing in the absorption apparatus (for example 60 bar) using the pump 304. The compressed methanol is subsequently supplied via conduit 312 to heat exchanger 302 in which against laden methanol from conduit 301 it is cooled further to the temperature prevailing in the absorption apparatus. The cryogenic, regenerated methanol finally passes via conduit 324 into the absorption apparatus in order therein to absorb undesired gas constituents from raw synthesis gas once more.

Since the compression of the regenerated methanol is carried out by pump 304 and pump 304 is arranged downstream of the intermediate vessel 320 the heat exchangers 317 and 319 arranged upstream of the intermediate vessel 320 may advantageously be operated at standard pressure or slight positive pressure.

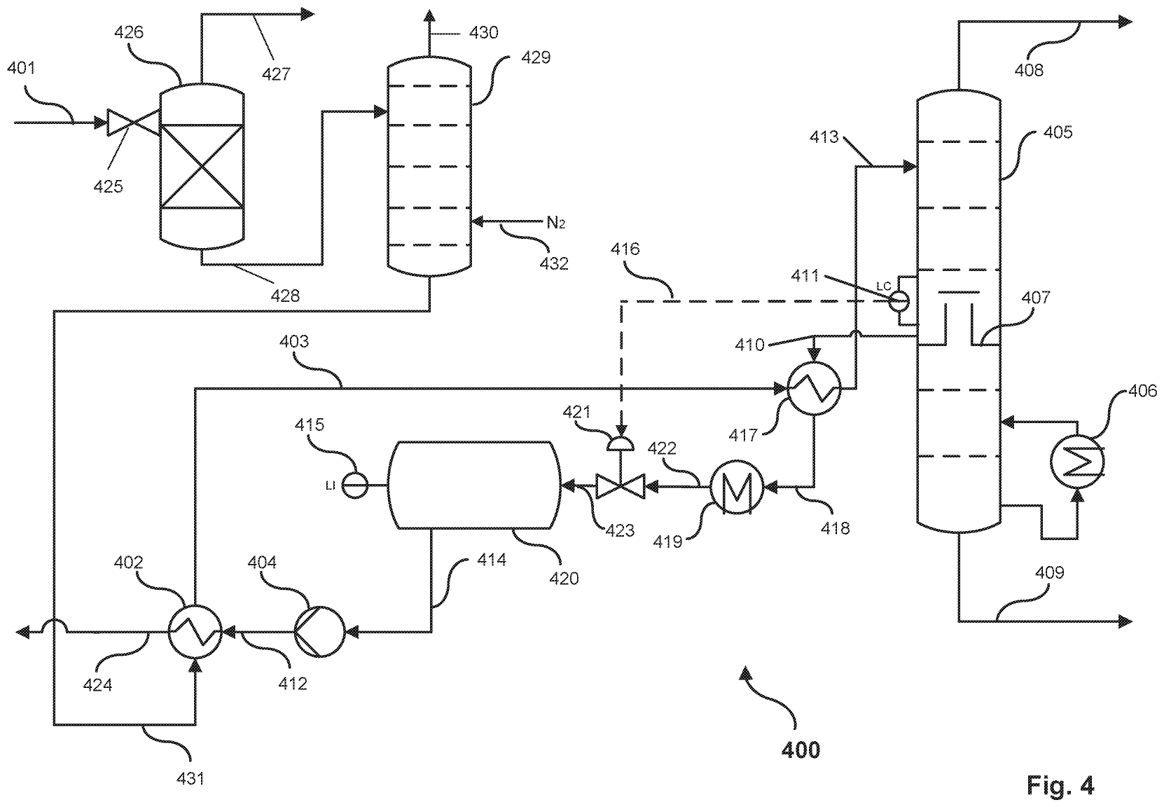

FIG. 4 shows a schematic flow diagram of a process or an apparatus 400 for regenerating a laden scrubbing medium according to a further working example of the invention. In the inventive example of FIG. 4 methanol is used as the scrubbing medium and regenerated using an apparatus for hot regeneration. Compared to the process mode of FIG. 3 after exiting the absorption apparatus the laden scrubbing medium is supplied initially to a flash vessel as the decompression stage and subsequently to a reabsorber before it is supplied to the regeneration apparatus.

Methanol laden at least with carbon dioxide (C₂), hydrogen sulfide (H₂S) and hydrogen cyanide (HCN) is supplied from an absorption apparatus (not shown) via conduit 401 and decompressed into the flash vessel (decompression stage) 426 via pressure reduction valve 425. Gases desorbed in the decompression exit the flash vessel 426 via conduit 427. Since the gases in conduit 427 contain valuable gases such as H₂ and CO they are recompressed via a compressor and supplied to the absorption apparatus once more. The cold gases withdrawn via conduit 427 may further be used for cooling elsewhere in the gas scrubbing process by indirect heat transfer with a further fluid. Examples include the cooling of the raw synthesis gas supplied to the absorption apparatus or the additional cooling of regenerated methanol from conduit 410 or from conduit 414, wherein the cooling takes place in the heat exchangers 417/402.

The methanol laden with a reduced gas concentration as a result of the decompression is withdrawn from the flash vessel via conduit 428 and supplied to a reabsorber 429. In the reabsorber 429 CO₂ is expelled (stripped) from the laden methanol by nitrogen supplied via conduit 432, it being unavoidable that certain amounts of hydrogen sulfide (H₂S) are co-expelled. Co-expelled H₂S gas is reabsorbed by laden methanol supplied via conduit 428. A substream of the hot regenerated methanol from conduit 424 may also be used for reabsorption (not shown). The gas stream containing mainly CO₂ and N₂ exits the reabsorber via conduit 430. Methanol laden mainly with H₂S is withdrawn from the reabsorber 429 via conduit 431 and in indirect heat exchanger 402 preheated against regenerated methanol from regeneration apparatus 405. The laden methanol subsequently passes into heat exchanger 417 where it is preheated against regenerated methanol from regeneration apparatus 405 in a further heat exchanger stage before it is supplied to the regeneration apparatus 405 via conduit 413. Regeneration apparatus 405 is in the form of a stripping column for hot regeneration and comprises a reboiler 406, a chimney tray 407 and an overhead condenser (not shown). Laden methanol is largely freed of H₂S in the regeneration apparatus 405 using methanol vapours produced by the reboiler 406. Abovementioned gas constituents not desired in the synthesis gas exit the regeneration apparatus 405 via conduit 408 together with methanol vapours not completely condensed by the overhead condenser. Once the methanol vapours have been condensed out of the H₂S- and HCN-containing acid gas mixture in a separator the acid gas mixture is supplied to a Claus plant for recovery of sulfur (not shown).

Accumulating in the lower region of the regeneration apparatus 405 is methanol enriched with water which is withdrawn via conduit 409 and supplied to a distillation apparatus for methanol-water separation.

Regenerated methanol freed of all acid gases accumulates on chimney tray 407. In the context of the invention chimney tray 407 is also referred to as the sump of the regeneration apparatus. The fill level on chimney tray 407 is controlled via the fill level control apparatus 411. Fill level control apparatus 411 controls the amount of regenerated methanol withdrawn from the regeneration apparatus via conduit 410. If the synthesis gas feed and thus the circulating amount of methanol is increased for example a greater amount of regenerated methanol per unit time is withdrawn via conduit 410 to keep constant the fill level on the chimney tray 407. Fill level control apparatus 411 controls the amount to be removed via conduit 410 using an actuated device, in this case control valve 421, which is in communication with fill level control apparatus 411 via a control circuit 416. Regenerated methanol withdrawn via conduit 410 is pre-cooled against laden methanol from conduit 403 in the indirect heat exchanger 417, passes via conduit 418 into a further heat exchanger 419 and finally via the conduits 422 and 423 and control valve 421 into intermediate vessel 420. Intermediate vessel 420 is configured for standard pressure or slight positive pressure as the operating pressure (for example 2 bar). Intermediate vessel 420 is optionally thermally insulated, i.e. provided on its outside with an insulating layer, in order that the pre-cooled regenerated methanol in the intermediate vessel 420 ideally does not undergo any warming. To check the fill level, intermediate vessel 420 is equipped with a fill level measuring apparatus 415. Intermediate vessel 420 is suitable for long-term storage of regenerated methanol and is therefore made of a material suitable therefor.

Although laden methanol is regenerated in an apparatus for hot regeneration 405 relatively small residual amounts of H₂S (trace amounts) nevertheless pass into the intermediate vessel 430 with the regenerated methanol. The use of the flash vessel 426 has the result that this H₂S amount is yet further reduced and this may advantageously be accounted for in the choice of material for the intermediate vessel 420.

Due to the presence of the intermediate container 420 in conjunction with the components 411, 416 and 421 of the control apparatus, regeneration apparatus 405, in particular the region around the chimney tray 407 or sump, is smaller than regeneration apparatuses 105, 205 of the comparative examples.

Pre-cooled, regenerated methanol is withdrawn from intermediate vessel 420 via conduit 414 and compressed to the pressure prevailing in the absorption apparatus (for example 60 bar) using the pump 404. The compressed methanol is subsequently supplied via conduit 412 to heat exchanger 402 in which against laden methanol from conduit 431 it is cooled further to the temperature prevailing in the absorption apparatus. The cryogenic, regenerated methanol finally passes via conduit 424 into the absorption apparatus in order therein to absorb undesired gas constituents from raw synthesis gas once more.

Since the compression of the regenerated methanol is carried out by pump 404 and pump 404 is arranged downstream of the intermediate vessel 420 the heat exchangers 417 and 419 arranged upstream of the intermediate vessel 420 may advantageously be operated at standard pressure or slight positive pressure.

The following numerical example shows a comparison between the embodiments of FIG. 3 and of FIG. 4 in respect of residual amounts (trace amounts) of valuable gases (H_{2,} CO) and H₂₅ detectable in the regenerated methanol of the intermediate vessel. The numerical example further shows the differences between the amounts of heat transferred in the main heat exchangers (302 and 317 in FIG. 3; 402 and 417 in FIG. 4) and the coolant consumption between the different absorption stages of the absorption apparatus.

In both examples (FIG. 3 and FIG. 4) the raw synthesis gas supplied to the absorption apparatus has the same composition according to the following table. A partially “shifted” raw synthesis gas is concerned, i.e. a portion of the carbon monoxide present in the raw synthesis gas was reacted with water to afford hydrogen and carbon dioxide in a water gas shift reaction.

| Component in raw | |
|---|---|
| synthesis gas | Proportion in mol % |
| CO | 27.80 |
| H₂ | 43.01 |
| CO₂ | 28.47 |
| N₂ | 0.38 |
| Ar | 0.10 |
| H₂S | 0.23 |
| COS | 0.01 |

The following values were calculated using the simulation software “Aspen Plus”. To aid comparison the numerical values calculated for the example of FIG. 3 were normalized, i.e. set to 100%. The volume flow of raw synthesis gas supplied to the absorption apparatus is 1 000 000 Nm³/h at an absorption pressure of 34 bar in both examples.

| | FIG. 3 example | FIG. 4 example |
|---|---|---|
| | (without flash vessel) | (with flash vessel) |
| Residual loading of valuable | 100% | 5% |
| gases (H₂, CO) in regenerated | | |
| methanol* | | |
| H₂ + CO recovery | 100% | 143% |
| Residual loading of H₂S in | 100% | 75% |
| regenerated methanol* | | |
| H₂S in Claus gas | 100% | 128% |
| Main heat exchanger | 100% | 94% |
| Coolant consumption | 100% | 86% |

*as detectable in intermediate vessel

The numerical values show the unexpected advantages of the inventive embodiment according to FIG. 4 (with flash vessel) compared to the inventive embodiment according to FIG. 3 (without flash vessel).

The use of a flash vessel (decompression stage) lowers the residual loading of valuable gases detectable in the regenerated methanol of the intermediate vessel significantly by a factor of 20. Correspondingly, somewhat larger amounts of H₂ and CO are recovered (43% increase). It is reiterated at this juncture that the abovementioned numbers relate to the residual loadings of valuable gases introduced into the regeneration apparatus (305, 405). Simultaneously, the residual loading of H₂S introduced into the intermediate vessel is reduced by 25% as a result of which the corresponding amount of H₂S in the “Claus gas” exiting the regeneration apparatus via the conduits 308/408 increases by 28%.

The use of a flash vessel has the further unexpected effect that compared to the main heat exchangers 302 and 317 the main heat exchangers 402 and 417 transfer an amount of heat that is 6% lower. Simultaneously, the coolant consumption of the coolant evaporators that cool the CO₂-laden methanol between the individual absorption stages of the absorption apparatus decreases.

Embodiments of the invention are described with reference to different types of subject-matter. In particular, certain embodiments are described with reference to process claims while other embodiments are described with reference to apparatus claims. However, it will be apparent to a person skilled in the art from the description hereinabove and hereinbelow that unless otherwise stated in addition to any combination of features belonging to one claim type, any combination of features relating to different types of subject matter or claim types may also be contemplated. All features may be combined to achieve synergistic effects which go beyond simple summation of the technical features.

While the invention has been represented and described in detail in the drawings and the preceding description, such a representation and description shall be considered elucidatory or exemplary and non-limiting. The invention is not limited to the disclosed embodiments. Other variations of the disclosed embodiments may be understood and carried out by those skilled in the art of the field of the claimed invention through study of the drawings, the disclosure and the dependent claims. Accordingly, it is intended to embrace all such alternatives, modifications, and variations as fall within the spirit and broad scope of the appended claims.

The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

### LIST OF REFERENCE SIGNS

100 Process/apparatus

101 Conduit

102 Heat exchanger

103 Conduit

104 Pump

105 Regeneration apparatus

106 Reboiler

107 Chimney tray

108 Conduit

109 Conduit

110 Conduit

111 Fill level measuring apparatus

112 Conduit

113 Conduit

200 Process/apparatus

201 Conduit

202 Heat exchanger

203 Conduit

204 Pump

205 Regeneration apparatus

206 Reboiler

207 Chimney tray

208 Conduit

209 Conduit

210 Conduit

211 Fill level measuring apparatus

212 Conduit

213 Conduit

214 Pump

215 Conduit

300 Process/apparatus

301 Conduit

302 Heat exchanger

303 Conduit

304 Pump

305 Regeneration apparatus

306 Reboiler

307 Chimney tray

308 Conduit

309 Conduit

310 Conduit

311 Fill level control apparatus

312 Conduit

313 Conduit

314 Conduit

315 Fill level measuring apparatus

316 Control circuit

317 Heat exchanger

318 Conduit

319 Heat exchanger

320 Intermediate vessel

321 Control valve

322 Conduit

323 Conduit

324 Conduit

400 Process/apparatus

401 Conduit

402 Heat exchanger

403 Conduit

404 Pump

405 Regeneration apparatus

406 Reboiler

407 Chimney tray

408 Conduit

409 Conduit

410 Conduit

411 Fill level control apparatus

412 Conduit

413 Conduit

414 Conduit

415 Fill level measuring apparatus

416 Control circuit

417 Heat exchanger

418 Conduit

419 Heat exchanger

420 Intermediate vessel

421 Control valve

422 Conduit

423 Conduit

424 Conduit

425 Pressure reduction valve

426 Flash vessel

427 Conduit

428 Conduit

429 Reabsorber

430 Conduit

431 Conduit

432 Conduit

1. A process for regenerating a laden scrubbing medium from a gas scrubbing for purification of raw synthesis gas, the process comprising the steps of:
at least partially freeing the laden scrubbing medium of bound gas constituents in a regeneration stage to obtain a regenerated scrubbing medium,
wherein after withdrawal from the regeneration stage, the regenerated scrubbing medium is supplied to an intermediate vessel and the regenerated scrubbing medium is withdrawn from the intermediate vessel and supplied to an absorption apparatus for purifying raw synthesis gas.

2. The process according to claim 1, wherein the gas scrubbing is a physical gas scrubbing.

3. The process according to claim 1, wherein the scrubbing medium comprises methanol as the main constituent, preferably consists of methanol.

4. The process according to claim 1, wherein laden scrubbing medium is withdrawn from the absorption apparatus and subsequently supplied to a decompression stage to obtain laden scrubbing medium having a reduced concentration of bound gas constituents which is withdrawn from the decompression stage and supplied to the regeneration stage.

5. The process according to claim 1, wherein the regenerated scrubbing medium is cooled after withdrawal from the regeneration stage and/or after withdrawal from the intermediate vessel.

6. The process according to claim 5, wherein the cooling is carried out by indirect heat transfer to a cold, laden scrubbing medium.

7. The process according to claim 1, wherein after withdrawal from the intermediate vessel the regenerated scrubbing medium is compressed to a pressure suitable for operating the absorption apparatus.

8. The process according to claim 1, wherein an amount of regenerated scrubbing medium present in the intermediate vessel is established as a controlled variable via a fill level of regenerated scrubbing medium in the regeneration stage.

9. The process according to claim 1, wherein the supplying to the intermediate vessel is carried out continuously or periodically or in batch operation.

10. The process according to claim 1, wherein the laden scrubbing medium is regenerated by stripping, preferably is regenerated by stripping with scrubbing medium vapour, in the regeneration stage.

11. The process according to claim 1, wherein the raw synthesis gas comprises at least carbon monoxide (CO), hydrogen (H₂), carbon dioxide (CO₂) and hydrogen sulfide (H₂S) and optionally at least one element from the group consisting of carbonyl sulfide (COS), mercaptans (RSH), hydrogen cyanide (HCN) and ammonia (NH₃).

12. An apparatus for regenerating a laden scrubbing medium from a gas scrubbing for purification of raw synthesis gas comprising the following constituents in fluid connection with one another:
a regeneration apparatus in which bound gas constituents are removable from a laden scrubbing medium; and
an intermediate vessel into which a regenerated scrubbing medium producible in the regeneration apparatus is transferable and in which the regenerated scrubbing medium is storable.

13. The apparatus according to claim 12, wherein a pump for compressing the regenerated scrubbing medium is arranged downstream of the intermediate vessel.

14. The apparatus according to claim 12, wherein a heat exchanger for cooling the regenerated scrubbing medium is arranged upstream and/or downstream of the intermediate vessel.

15. The apparatus according to claim 12, wherein the regeneration apparatus comprises a stripping column comprising a reboiler, overhead condenser and at least one gas-permeable tray.

16. The apparatus according to claim 12, wherein the intermediate vessel has an actuated device for flow rate control arranged upstream of it.

17. The apparatus according to claim 16, wherein the regeneration apparatus comprises a control apparatus for controlling the flow rate of the actuated device via a fill level of regenerated scrubbing medium in the regeneration apparatus as a controlled variable, thus establishing a fill level of regenerated scrubbing medium in the intermediate vessel.
